(19) United States
(12) Patent Application Publication
(10) Pub. No.: US 2013/0077918 A1
(43) Pub. Date: Mar. 28, 2013

(54) INPUT DEVICE

(71) Applicants: Toru Mizutani, Ibaraki-shi (JP); Naoki Shibata, Ibaraki-shi (JP)

(72) Inventors: Toru Mizutani, Ibaraki-shi (JP); Naoki Shibata, Ibaraki-shi (JP)

(73) Assignee: NITTO DENKO CORPORATION, Osaka (JP)

(21) Appl. No.: 13/613,675

(22) Filed: Sep. 13, 2012

(30) Foreign Application Priority Data
Sep. 26, 2011 (JP) 2011-209883

(51) Int. Cl. G02B 6/26

(52) U.S. Cl. 385/39

(57) ABSTRACT

An input device is provided which prevents unwanted light beams leaking through the ending end surface of a light-emitting main core from reaching a light-receiving element. The input device includes an optical waveguide having a rectangular hollow interior, a light-emitting element connected to the starting end of the light-emitting main core, and a light-receiving element connected to the ending ends of light-receiving cores. The light-receiving element is positioned close to the ending end of the light-emitting main core. A void (an air space) is provided between the ending end of the light-emitting main core and the light-receiving element. The air space causes unwanted light beams leaking through the ending end surface of the light-emitting main core to diffuse, thereby preventing the unwanted light beams from reaching the light-receiving element.

### BACKGROUND OF THE INVENTION

1. Field of the Invention

The present invention relates to an input device including an optical position detection means.

2. Description of the Related Art

Conventionally, an optical position detection device (as disclosed in, for example, Japanese Patent No. 3682109) including a plurality of light-emitting elements and a plurality of light-receiving elements is proposed as an input device. This optical position detection device is in the form of a rectangular frame comprised of a pair of L-shaped sections. The light-emitting elements are disposed in juxtaposition in one of the L-shaped sections of the rectangular frame, and the light-receiving elements opposed to the light-emitting elements are disposed in juxtaposition in the other L-shaped section thereof. The rectangular frame-shaped optical position detection device is placed along the periphery of a rectangular display. Information such as a character is inputted to the optical position detection device and is caused to appear on the rectangular display by moving a pen within the rectangular frame of the optical position detection device.

Specifically, the light-emitting elements cause light beams to travel in a lattice form within the rectangular frame. When a pen is moved within the rectangular frame, some of the light beams emitted from the light-emitting elements are intercepted by the tip of the pen. The light-receiving elements opposed to the light-emitting elements sense the interception of light beams to thereby detect the path of the tip of the pen (input information such as a character). The path is outputted as a signal to the rectangular display.

The light-emitting elements and the light-receiving elements of the optical position detection device have a certain amount of thickness, and the optical position detection device includes the light-emitting elements and the light-receiving elements disposed in juxtaposition in the form of a frame. For this reason, the frame is accordingly thick. To reduce the thickness of the frame, an input device including an optical waveguide has been proposed (for example, Japanese Patent Application No. 2011-139481).

This input device includes a rectangular frame-shaped optical waveguide W₀, as shown in plan view in FIG. 7A. The rectangular frame of the optical waveguide W₀ is comprised of a pair of L-shaped sections. One of the L-shaped sections serves as a light-emitting side A, and the other L-shaped section serves as a light-receiving side B. A main core 2, and branch cores 2a branching off from the main core 2 at predetermined spaced intervals are formed on the light-emitting side A. Cores 2b are disposed in juxtaposition at predetermined spaced intervals on the light-receiving side B. The tips of the light-emitting branch cores 2a and the tips of the light-receiving cores 2b are positioned on inner edges of the pair of L-shaped sections (the inner peripheral edges of the rectangular frame), and are in an opposed relationship with each other. A light-emitting element 5 is connected to the starting end of the light-emitting main core 2, and a light-receiving element 6 is connected to the ending ends of the light-receiving cores 2b. Light beams from the light-emitting element 5 pass through the light-emitting main core 2, and exit the tips of the branch cores 2a. Upon exiting, the light beams H travel in a lattice form within the rectangular frame of the rectangular frame-shaped optical waveguide W₀. Then, the light beams H enter the tips of the light-receiving cores 2b, pass through the light-receiving cores 2b, and reach the light-receiving element 6.

However, in the input device configured such that the light-receiving element 6 is positioned close to the ending end 2A of the light-emitting main core 2 as shown in FIG. 7A, there are cases where the light-receiving element 6 does not sense the interception of light beams by the tip of a pen when the pen is moved within the rectangular frame. As shown in FIG. 7B in an enlarged view of a portion enclosed with a circle C of FIG. 7A (a portion around the light-receiving element 6), some of the light beams emitted from the light-emitting element 5 leak through the ending end surface 2A of the light-emitting main core 2, travel directly from the light-emitting side A to the light-receiving side B in the optical waveguide W₀, and reach the light-receiving element 6 (indicated by dash-double-dot arrows in FIG. 7B). A similar phenomenon also occurs when a branch core 2a extends from the ending end surface 2A of the main core 2 as shown in FIG. 7C. The light-receiving element 6 should sense a portion where light beams are intercepted by the pen tip as a portion where “the amount of light is small.” However, the light-receiving element 6 does not sense the reduction in the amount of light because unwanted light beams reach the light-receiving element 6 as mentioned above.

### SUMMARY OF THE INVENTION

In view of the foregoing, an input device is provided which is capable of preventing unwanted light beams leaking through the ending end surface of a light-emitting main core from reaching a light-receiving element when the light-receiving element is positioned closer to the ending end of the light-emitting main core.

The input device comprises: a frame-shaped optical waveguide having first and second sections opposed to each other in the form of a frame, the first section including a light-emitting main core and a plurality of branch cores branching off from the main core, the second section including a plurality of light-receiving cores disposed in juxtaposition, the branch cores and the light-receiving cores having respective tip surfaces positioned on inner edges of the frame, the tip surfaces of the branch cores and the tip surfaces of the light-receiving cores being opposed to each other; a light-emitting element connected to the starting end of the light-emitting main core of the optical waveguide; and a light-receiving element connected to the ending ends of the light-receiving cores of the optical waveguide, the light-receiving element being positioned close to the ending end of the light-emitting main core, wherein most of the light beams emitted from the light-emitting element and traveling from the starting end of the light-emitting main core toward the ending end thereof exit the tip surfaces of the branch cores, and the remainder of the light beams leak through the ending end surface of the light-emitting main core toward the light-receiving element, the optical waveguide including a void provided between the ending end of the light-emitting main core and the light-receiving element, there being an air space provided by air positioned in the void, the air space serving as a light transmission preventing means for diffusing the leaking light beams to prevent the leaking light beams from reaching the light-receiving element.

It should be noted that the term “a branch core branching off from a main core” shall be meant to include a branch core extending from the ending end surface of a main core, as shown in FIG. 7C.

In the input device, the void is provided between the ending end of the light-emitting main core and the light-receiving element, and the air space is provided by air positioned in the void. This allows the unwanted light beams emitted from the light-emitting element and leaking through the ending end surface of the light-emitting main core toward the light-receiving element to diffuse because of a difference in refractive index between the optical waveguide and the air space, thereby preventing the unwanted light beams from reaching the light-receiving element. Thus, when a pen is moved within the frame of the frame-shaped optical waveguide in the input device, the light-receiving element is able to properly sense a portion where light beams are intercepted by the tip of the pen as a portion where the amount of light is reduced.

Preferably, a light-shielding member is provided in the void. In such a case, the unwanted light beams leaking through the ending end surface of the light-emitting main core are prevented from reaching the light-receiving element with higher reliability.

Preferably, the light-shielding member includes a metal tape or a resin containing a light absorbing agent. In such a case, the transmission of the light beams to the light-receiving element is prevented more easily.

### BRIEF DESCRIPTION OF THE DRAWINGS

FIG. 1A is a plan view schematically showing an input device according to a first preferred embodiment.

FIG. 1B is a sectional view, on an enlarged scale, of the input device taken along the line D1-D1 of FIG. 1A.

FIGS. 2A to 2C, 3A to 3C, 4A and 4B are views schematically illustrating an exemplary method of producing the input device.

FIG. 5A is a plan view schematically showing the input device according to a second preferred embodiment.

FIG. 5B is a sectional view, on an enlarged scale, of the input device taken along the line D2-D2 of FIG. 5A.

FIG. 6A is a plan view schematically showing the input device according to a third preferred embodiment.

FIG. 6B is a sectional view, on an enlarged scale, of the input device taken along the line D3-D3 of FIG. 6A.

FIG. 7A is a plan view schematically showing a conventional input device.

FIG. 7B is an enlarged view of a portion enclosed with a circle C of FIG. 7A.

FIG. 7C shows another example of the portion of FIG. 7B.

### DETAILED DESCRIPTION OF THE INVENTION

Preferred embodiments according to the present invention will now be described in detail with reference to the drawings.

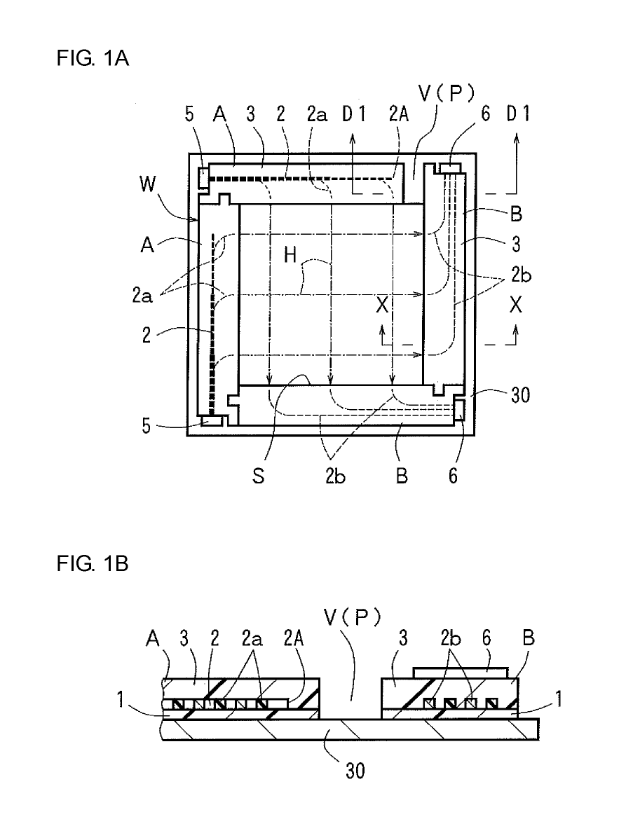

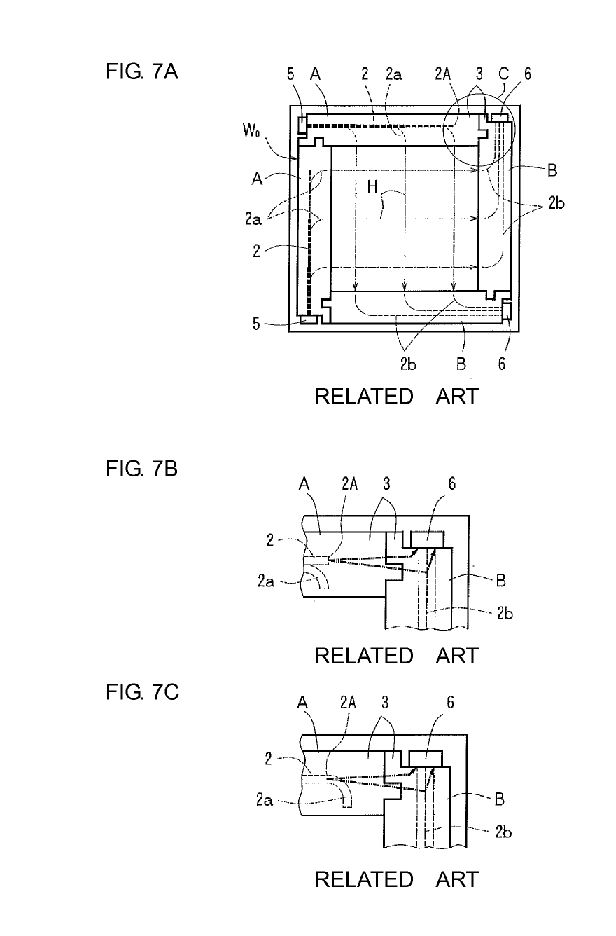

FIG. 1A is a plan view showing an input device according to a first preferred embodiment. FIG. 1B is a sectional view, on an enlarged scale, of the input device taken along the line D1-D1 of FIG. 1A. The input device according to the first preferred embodiment is configured such that a void V is provided between the ending end 2A of a light-emitting main core 2 of an optical waveguide W and a light-receiving element 6 in the conventional input device shown in FIGS. 7A to 7C, and such that an air space P is provided by air positioned in the void V. The air space P causes unwanted light beams emitted from a light-emitting element 5 and leaking through the ending end surface 2A of the light-emitting main core 2 toward the light-receiving element 6 to diffuse because of a difference in refractive index between an over cladding layer 3 of the optical waveguide W and the air space P, thereby preventing the unwanted light beams from reaching the light-receiving element 6. Thus, when a pen is moved within the rectangular frame of the rectangular frame-shaped optical waveguide W in the input device, the light-receiving element 6 is able to properly sense a portion where light beams are intercepted by the tip of the pen as a portion where the amount of light is reduced.

This will be described in further detail. The optical waveguide W is configured such that strip-shaped optical waveguide sections are produced individually and then connected together into the shape of the rectangular frame. The void V (the air space P) is provided at one corner (in FIG. 1A, the upper right corner) of the rectangular frame. In the first preferred embodiment, end edges of each of the strip-shaped optical waveguide sections have step portions at the corners other than the one corner at which the void V is provided. Adjacent ones of the optical waveguide sections, which are positioned relative to each other using the step portions, are connected to each other. The interior of the frame of the rectangular frame-shaped optical waveguide W serves as a rectangular hollow input-use interior (window) S.

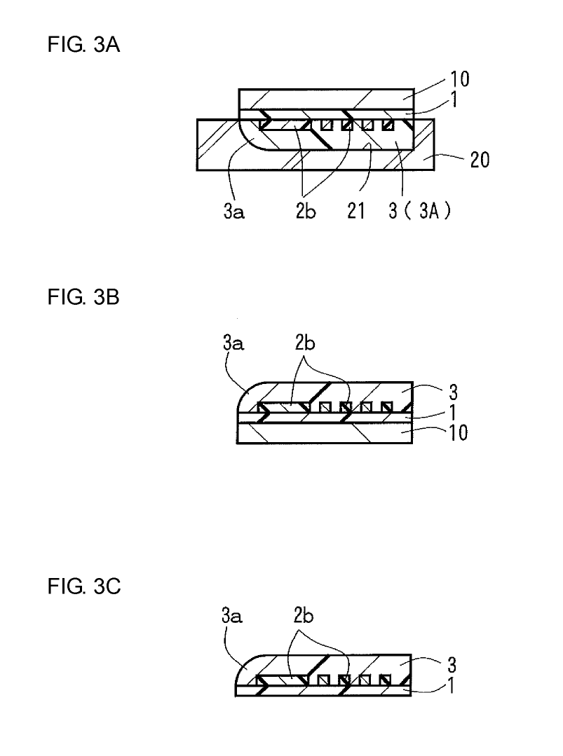

The optical waveguide W in the form of the rectangular frame is comprised of a pair of L-shaped sections. One of the L-shaped sections serves as a light-emitting side A, and the other L-shaped section serves as a light-receiving side B. On the light-emitting side A, the main core 2 and branch cores 2a branching off from the main core 2 at predetermined spaced intervals are formed on a surface of an under cladding layer 1, and the over cladding layer 3 is formed to cover the main core 2 and the branch cores 2a. On the light-receiving side B, cores 2b disposed in juxtaposition at predetermined spaced intervals are formed on the surface of the under cladding layer 1, and the over cladding layer 3 is formed to cover the cores 2b. The tip surfaces of the light-emitting branch cores 2a and the tip surfaces of the light-receiving cores 2b are positioned on inner edges of the pair of L-shaped sections (the inner peripheral edges of the rectangular frame), and are in opposed relation to each other. In the first preferred embodiment, each of the tips of the light-emitting branch cores 2a and the light-receiving cores 2b positioned on the inner peripheral edges of the rectangular frame is in the form of a convex lens portion having a substantially semicircular curved surface as seen in plan view, and an edge portion of the over cladding layer 3 covering the lens portions is in the form of a convex lens portion 3a (with reference to FIG. 3C) having a substantially quadrantal curved surface as seen in sectional side view.

In FIG. 1A, the light-emitting main core 2, the light-emitting branch cores 2a, and light-receiving cores 2b are indicated by broken lines, and the thickness of the broken lines indicates the width of the light-emitting main core 2, the light-emitting branch cores 2a, and light-receiving cores 2b. Also, in FIGS. 1A and 1B, the number of light-emitting branch cores 2a and the number of light-receiving cores 2b are shown as abbreviated.

The starting end of the light-emitting main core 2 and the ending ends of the light-receiving cores 2b are positioned outside the corners of the rectangular frame. The light-emitting element 5 such as a VCSEL (vertical cavity surface emitting laser) is connected to the starting end of the light-emitting main core 2, and the light-receiving element 6 such as a CMOS (complementary metal-oxide-semiconductor) sensor is connected to the ending ends of the light-receiving cores 2b.

The optical waveguide W, the light-emitting element 5, and the light-receiving element 6 are provided on a surface of a rectangular frame-shaped retainer plate 30 having the hollow input-use interior S, and are covered with a rectangular frame-shaped protective plate (not shown) having the hollow input-use interior S. The input device has such a configuration.

In the input device having such a configuration, most of the light beams emitted from the light-emitting element 5 pass through the light-emitting main core 2 and through the branch cores 2a, travel via the lens portions at the tips of the respective branch cores 2a, and exit the surface of the lens portion 3a of the over cladding layer 3 covering the lens portions of the respective branch cores 2a. Upon exiting, the light beams H travel in a lattice form in the region within the hollow input-use interior S of the rectangular frame-shaped optical waveguide W. The light beams H traveling in a lattice form are restrained from diverging by refraction through the lens portions at the tips of the light-emitting branch cores 2a and through the lens portion 3a of the over cladding layer 3 covering the lens portions of the light-emitting branch cores 2a. The light beams H are transmitted through the lens portion 3a of the over cladding layer 3 on the light-receiving side B and through the lens portions at the tips of the respective light-receiving cores 2b. Then, the light beams H pass through the light-receiving cores 2b to reach the light-receiving element 6. The light beams entering the light-receiving cores 2b are narrowed down and converged by refraction through the lens portion 3a of the over cladding layer 3 and through the lens portions at the tips of the light-receiving cores 2b.

An example of the operation of inputting information by means of the input device is as follows. A user places the input device on a paper sheet, and inputs a character, a drawing, a mark or the like with a pen into part of the paper sheet revealed within the hollow input-use interior S where the light beams H travel in the lattice form as mentioned above. Because of the input operation, some of the light beams H traveling in the lattice form are intercepted by the tip of the pen. The light-receiving element 6 senses the interception of light beams to thereby detect the path of the pen tip. The path of the pen tip serves as input information such as a character, a drawing, a mark or the like.

In the operation of inputting information as described above, most of the light beams emitted from the light-emitting element 5 and traveling from the starting end toward the ending end of the light-emitting main core 2 in the input device exit the lens portions at the tips of the light-emitting branch cores 2a, but the remainder (light beams that do not exit the lens portions at the tips of the light-emitting branch cores 2a) leak through the ending end surface 2A of the light-emitting main core 2 toward the light-receiving element 6 to reach the void V (the air space P) provided between the ending end 2A of the light-emitting main core 2 and the light-receiving element 6. The leaking light beams are unwanted light beams, and are diffused upon reaching the air space P because of a difference in refractive index between the over cladding layer 3 of the optical waveguide W and the air space P. Thus, most of the unwanted light beams are prevented from reaching the light-receiving element 6. Thus, when a pen is moved within the rectangular frame of the rectangular frame-shaped optical waveguide W in the input device, the light-receiving element 6 is able to properly sense a portion where light beams are intercepted by the tip of the pen as a portion where the amount of light is reduced.

Such an input device is used together with, for example, a personal computer. Specifically, when information such as a document is displayed on a display for the personal computer and a user adds information such as a character, a drawing and a mark to the displayed information, the user inputs the information such as a character into the region within the hollow input-use interior S of the input device with a pen. In response to the input operation, the input device detects the path of the tip of the pen, and transmits the path as a signal to the personal computer by radio or through a connecting cable, so that the information appears on the display. The information such as a character inputted by means of the input device which is superimposed on the information such as a document appears on the display.

Software (a program) for converting coordinates in the region within the hollow input-use interior S of the input device into coordinates on the screen of the display to display a character or the like inputted by means of the input device on the display is incorporated in the personal computer used herein for the purpose of displaying the character or the like inputted in the hollow input-use interior S of the input device in a position on the display corresponding to the input position. The information such as a document is, in general, previously stored in an information storage medium such as a hard disk in the personal computer and an external USB memory device, and is outputted from the information storage medium. The information appearing on the display which is the superimposition of the information such as a character inputted by means of the input device on the information such as a document may be stored in the information storage medium.

Another method of use of the input device includes the use thereof as a detection means for detecting a finger touch position on a touch panel by means of the position detection capability thereof. Specifically, the rectangular frame-shaped input device is placed along the periphery of a display screen of the touch panel, and is then used. Because of such use, when a portion of the display screen of the touch panel is touched with a finger, the light-receiving element 6 senses the interception of light beams with the finger to detect the position (coordinates) of the portion touched with the finger.

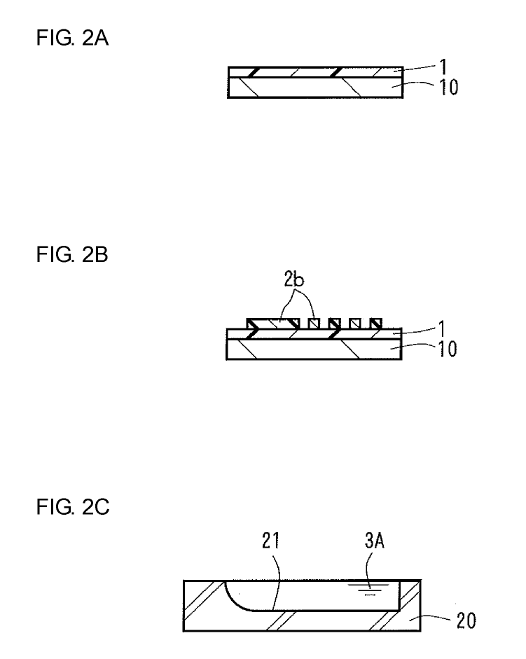

Next, an exemplary method of producing the input device will be described. In the first preferred embodiment, the rectangular frame-shaped optical waveguide W is produced by individually producing the strip-shaped optical waveguide sections corresponding to the respective sides of the rectangular frame of the optical waveguide W and then connecting the strip-shaped optical waveguide sections together into the shape of the rectangular frame. It should be noted that FIGS. 2A to 2C, and 3A to 3C referenced for description on the method of producing the optical waveguide W show portions corresponding to a cross section taken along the line X-X of FIG. 1A (a cross section of an optical waveguide section on the light-receiving side B).

First, a substrate 10 for the formation of each of the strip-shaped optical waveguide sections (with reference to FIG. 2A) is prepared. Examples of a material for the formation of the substrate 10 include metal, resin, glass, quartz, and silicon.

Then, as shown in FIG. 2A, the strip-shaped under cladding layer 1 is formed on a surface of the substrate 10. The under cladding layer 1 may be formed by a photolithographic method using a photosensitive resin as a material for the formation thereof. The under cladding layer 1 has a thickness in the range of 5 to 50 μm, for example.

Next, in each of the optical waveguide sections corresponding to the light-emitting side A (with reference to FIG. 1A), the light-emitting main core 2 and the light-emitting branch cores 2a which have the aforementioned pattern are formed on the surface of the under cladding layer 1 by a photolithographic method, as shown in FIG. 2B. In each of the optical waveguide sections corresponding to the light-receiving side B (with reference to FIG. 1A), the light-receiving cores 2b which have the aforementioned pattern are formed on the surface of the under cladding layer 1 by a photolithographic method. An example of a material for the formation of the light-emitting main core 2, the light-emitting branch cores 2a, and the light-receiving cores 2b used herein includes a photosensitive resin having a refractive index higher than that of the materials for the formation of the under cladding layer 1 and the over cladding layer 3 to be described below (with reference to FIG. 3B). The light-emitting main core 2 and the light-emitting branch cores 2a are not shown in FIG. 2B because FIG. 2B is a sectional view on the light-receiving side B. The same applies to FIGS. 3A to 3C below.

As shown in FIG. 2C, a light-transmissive mold 20 for the formation of the over cladding layer 3 is prepared. The mold 20 includes a cavity 21 having a mold surface complementary in shape to the surface of the over cladding layer 3 (with reference to FIG. 3B). The mold 20 is placed on a molding stage (not shown), with the cavity 21 positioned to face upward. Then, the cavity 21 is filled with a photosensitive resin 3A serving as the material for the formation of the over cladding layer 3.

Then, as shown in FIG. 3A, the light-emitting main core 2 and the light-emitting branch cores 2a patterned on the surface of the under cladding layer 1, and the light-receiving cores 2b patterned on the surface of the under cladding layer 1 are positioned relative to the cavity 21 of the mold 20. In that state, the under cladding layer 1 is pressed against the mold 20, so that the light-emitting main core 2, the light-emitting branch cores 2a, and the light-receiving cores 2b are immersed in the photosensitive resin 3A serving as the material for the formation of the over cladding layer 3. In this state, the photosensitive resin 3A is exposed to irradiation light such as ultraviolet light by directing the irradiation light through the mold 20 onto the photosensitive resin 3A. This exposure cures the photosensitive resin 3A to form the over cladding layer 3 in which a portion thereof corresponding to the tips of the light-emitting branch cores 2a and a portion thereof corresponding to the tips of the light-receiving cores 2b are each formed as the lens portion 3a.

Next, as shown in FIG. 3B (shown in an orientation vertically inverted from that shown in FIG. 3A), the over cladding layer 3 is removed from the mold 20 (with reference to FIG. 3A). At this time, the over cladding layer 3 is removed together with the substrate 10, the under cladding layer 1, the light-emitting main core 2, and the light-emitting branch cores 2a on the light-emitting side A (with reference to FIG. 1A), and the over cladding layer 3 is removed together with the substrate 10, the under cladding layer 1, and the light-receiving cores 2b on the light-receiving side B (with reference to FIG. 1A).

Then, as shown in FIG. 3C, the substrate 10 (with reference to FIG. 2B) is stripped from the under cladding layer 1. This stripping provides each of the strip-shaped optical waveguide sections on the light-emitting side A including the under cladding layer 1, the light-emitting main core 2, the light-emitting branch cores 2a and the over cladding layer 3, and provide s each of the strip-shaped optical waveguide sections on the light-receiving side B including the under cladding layer 1, the light-receiving cores 2b and the over cladding layer 3.

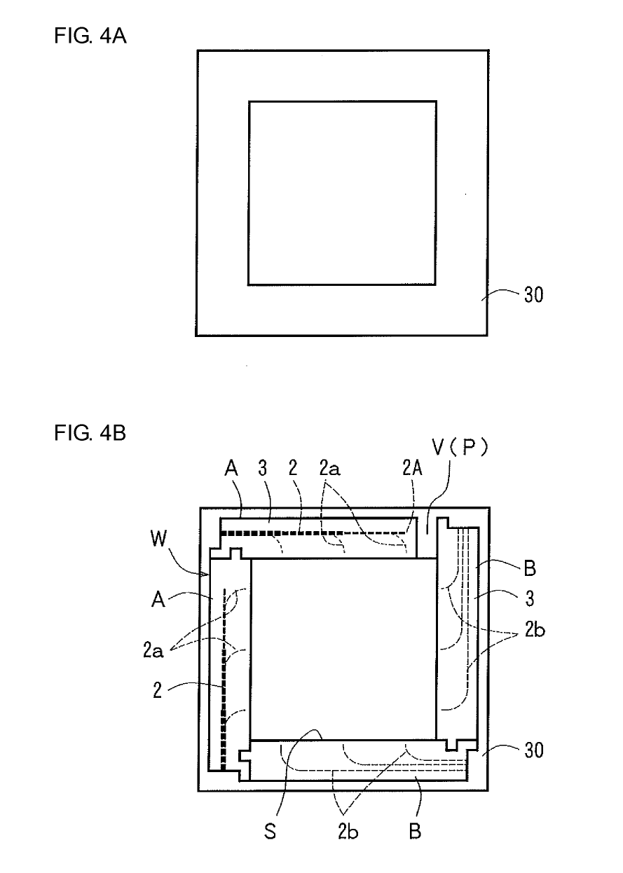

The rectangular frame-shaped retainer plate 30 having the hollow input-use interior S is prepared, as shown in plan view in FIG. 4B. Examples of a material for the formation of the retainer plate 30 include metal, resin, glass, quartz, and silicon. In particular, stainless steel is preferable in that it has a good ability to hold its planarity. The retainer plate 30 has a thickness of approximately 0.5 mm, for example.

As shown in FIG. 4B, the strip-shaped optical waveguide sections are affixed in the form of a rectangular frame to the surface of the rectangular frame-shaped retainer plate 30. At this time, the ending end 2A of the light-emitting main core 2 and the ending ends of the light-receiving cores 2b are positioned at one corner (in FIG. 4B, the upper right corner) of the rectangular frame. Further, the void V is provided between the ending end 2A of the light-emitting main core 2 and the ending ends of the light-receiving cores 2b. In this manner, the rectangular frame-shaped optical waveguide W is produced on the surface of the rectangular frame-shaped retainer plate 30.

Next, as shown in FIG. 1A, the light-emitting element 5 is connected to the starting end of the light-emitting main core 2, and the light-receiving element 6 is connected to the ending ends of the light-receiving cores 2b. Thereafter, the top surface of the over cladding layer 3 except the lens portion 3a, the light-emitting element 5, and the light-receiving element 6 are covered with the rectangular frame-shaped protective plate (not shown). Examples of a material for the formation of the protective plate include resin, metal, glass, quartz, and silicon. The protective plate has a thickness of approximately 0.5 mm when made of metal, and approximately 0.8 mm when made of resin, for example. In this manner, the input device shown in FIGS. 1A and 1B is produced.

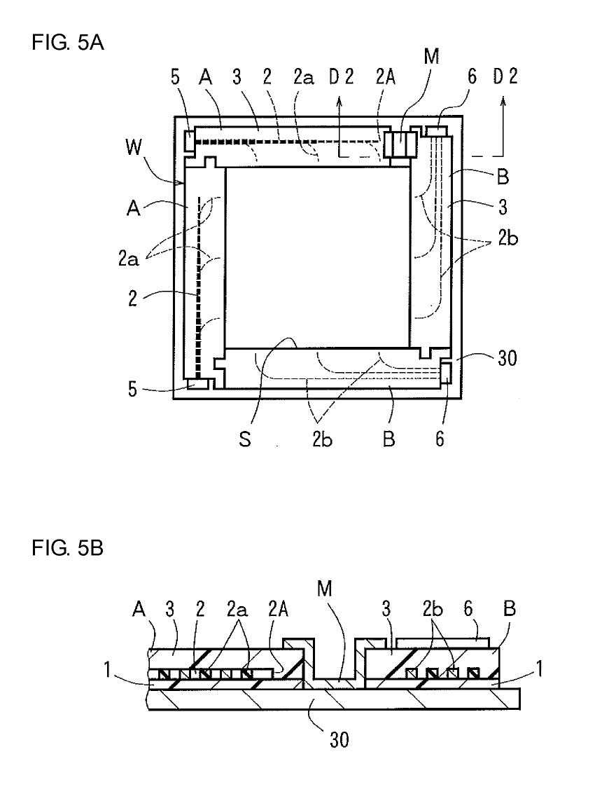

FIG. 5A is a plan view showing the input device according to a second preferred embodiment. FIG. 5B is a sectional view, on an enlarged scale, of the input device taken along the line D2-D2 of FIG. 5A. The input device according to the second preferred embodiment is configured such that a metal tape M such as an aluminum tape is affixed in the void V provided at one corner of the rectangular frame-shaped optical waveguide W of the first preferred embodiment (with reference to FIGS. 1A and 1B). Other parts of the second preferred embodiment are similar to those of the first preferred embodiment described above. Like reference numerals and characters are used in the second preferred embodiment to designate parts similar to those of the first preferred embodiment.

In the second preferred embodiment, the metal tape M intercepts unwanted light beams emitted from the light-emitting element 5 and leaking through the ending end surface 2A of the light-emitting main core 2 toward the light-receiving element 6 to prevent the unwanted light beams from reaching the light-receiving element 6. Thus, when a pen is moved within the rectangular frame of the rectangular frame-shaped optical waveguide W in the input device of the second preferred embodiment in a manner similar to that in the first preferred embodiment, the light-receiving element 6 is able to properly sense a portion where light beams are intercepted by the tip of the pen as a portion where the amount of light is reduced.

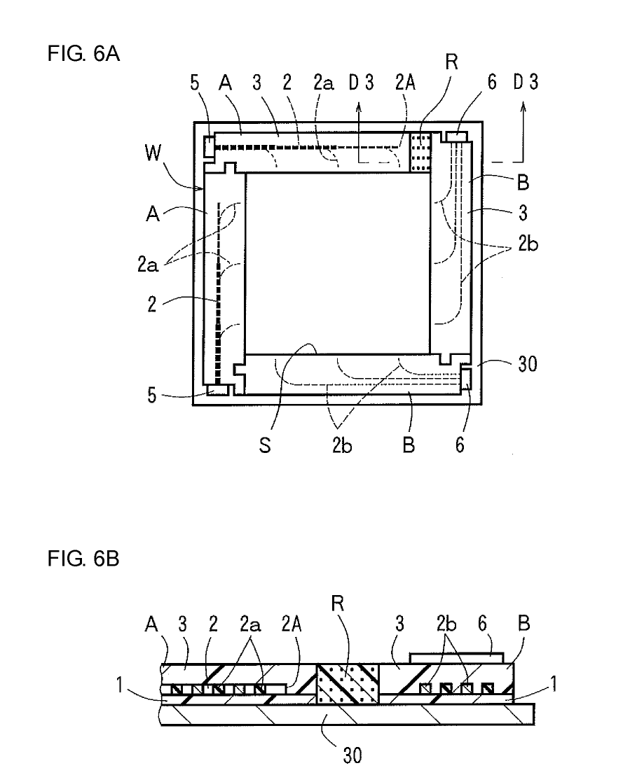

FIG. 6A is a plan view showing the input device according to a third preferred embodiment. FIG. 6B is a sectional view, on an enlarged scale, of the input device taken along the line D3-D3 of FIG. 6A. The input device according to the third preferred embodiment is configured such that the void V provided in the optical waveguide W of the first preferred embodiment (with reference to FIGS. 1A and 1B) is filled with a resin R containing a light absorbing agent. Other parts of the third preferred embodiment are similar to those of the first preferred embodiment described above. Like reference numerals and characters are used in the third preferred embodiment to designate parts similar to those of the first preferred embodiment.

In the third preferred embodiment, the light absorbing agent contained in the resin R absorbs most of the unwanted light beams emitted from the light-emitting element 5 and leaking through the ending end surface 2A of the light-emitting main core 2 toward the light-receiving element 6 to prevent most of the unwanted light beams from reaching the light-receiving element 6. Thus, when a pen is moved within the rectangular frame of the rectangular frame-shaped optical waveguide W in the input device of the third preferred embodiment in a manner similar to that in the first preferred embodiment, the light-receiving element 6 is able to properly sense a portion where light beams are intercepted by the tip of the pen as a portion where the amount of light is reduced.

In the second and third preferred embodiments, the metal tape M and the resin R containing the light absorbing agent are provided as a light-shielding member in the void V provided in the optical waveguide W. However, other light-shielding members may be used. Examples of the light-shielding member used herein include metal plates, resin impervious to light, rubber and paper.

For the purpose of improving the light transmission efficiency within the hollow input-use interior S of the rectangular frame-shaped optical waveguide W of the input device according to the aforementioned preferred embodiments, the tips of the light-emitting branch cores 2a and the tips of the light-receiving cores 2b are formed as the lens portions, and the edge portion of the over cladding layer 3 covering the lens portions of the cores 2a and 2b is formed as the lens portion 3a. However, when the light transmission efficiency within the hollow input-use interior S is sufficient, the aforementioned lens portion(s) may be formed only in either the light-emitting branch cores 2a and the light-receiving cores 2b or the over cladding layer 3, or may be formed in neither the cores 2a and 2b nor the over cladding layer 3. When the aforementioned lens portions are not formed, a separate lens element may be prepared and provided along the periphery within the hollow input-use interior S of the optical waveguide W.

In the aforementioned preferred embodiments, a method in which a pen (a writing implement) is used to write on a paper sheet therewith is given as an example of the method of inputting information. However, a thin rod, a human finger, and the like may be used in place of the pen, if there is no need to write on a paper sheet.

In the aforementioned preferred embodiments, a method in which the input device is used together with a personal computer and the information inputted to the input device is displayed on a display for the personal computer is given as an example of the method of the use of the input device. Alternatively, functionality similar to that of the personal computer in the aforementioned preferred embodiments may be imparted to the input device or to the display, so that information is displayed on the display without using the personal computer.

Next, inventive examples of the present invention will be described in conjunction with a comparative example. It should be noted that the present invention is not limited to the inventive examples.

### EXAMPLES

### Inventive Example 1

### <Material for Formation of Under Cladding Layer>

Component A: 75 parts by weight of an epoxy resin containing an alicyclic skeleton (EHPE 3150 available from Daicel Chemical Industries, Ltd.).

Component B: 25 parts by weight of an epoxy-group-containing acrylic polymer (MARPROOF G-0150M available from NOF Corporation).

Component C: four parts by weight of a photo-acid generator (CPI-200K available from San-Apro Ltd.).

A material for the formation of an under cladding layer was prepared by dissolving the components A to C together with five parts by weight of an ultraviolet absorber (TINUVIN 479 manufactured by Ciba Japan K.K.) in cyclohexanone (a solvent).

### <Material for Formation of Cores>

Component D: 85 parts by weight of an epoxy resin containing a bisphenol A skeleton (157S70 available from Japan Epoxy Resins Co., Ltd.).

Component E: five parts by weight of an epoxy resin containing a bisphenol A skeleton (EPIKOTE 828 available from Japan Epoxy Resins Co., Ltd.).

Component F: 10 parts by weight of an epoxy-group-containing styrenic polymer (MARPROOF G-0250SP available from NOF Corporation).

A material for the formation of cores was prepared by dissolving the components D to F and four parts by weight of the aforementioned component C in ethyl lactate.

### <Material for Formation of Over Cladding Layer>

Component G: 100 parts by weight of an epoxy resin having an alicyclic skeleton (EP4080E available from ADEKA Corporation).

A material for the formation of an over cladding layer was prepared by mixing the component G and two parts by weight of the aforementioned component C together.

### <Production of Optical Waveguide>

The material for the formation of the under cladding layer was applied to a surface of a substrate made of stainless steel (having a thickness of 50 μm). Thereafter, a heating treatment was performed at 160° C. for two minutes to form a photosensitive resin layer. Then, the photosensitive resin layer was exposed to ultraviolet light at an integrated dose of 1000 mJ/cm². Thus, the under cladding layer having a thickness of 10 μm (with a refractive index of 1.510 at a wavelength of 830 nm) was formed.

Then, the material for the formation of the cores was applied to a surface of the under cladding layer. Thereafter, a heating treatment was performed at 170° C. for three minutes to form a photosensitive resin layer. Next, the photosensitive resin layer was exposed to ultraviolet light at an integrated dose of 3000 mJ/cm² through a photomask (with a gap of 100 μm). Subsequently, a heating treatment was performed at 120° C. for 10 minutes. Thereafter, development was performed using a developing solution (γ-butyrolactone) to dissolve away unexposed portions. Thereafter, a drying process was performed at 120° C. for five minutes. Thus, a light-emitting main core and light-emitting branch cores (with a refractive index of 1.570 at a wavelength of 830 nm) were patterned on a light-emitting side, and light-receiving cores (with a refractive index of 1.570 at a wavelength of 830 nm) were patterned on a light-receiving side. The dimensions of the light-emitting branch cores and the light-receiving cores were as follows: 30 μm in width and 50 μm in height.

A light-transmissive mold for the formation of the over cladding layer was prepared. This mold includes a cavity having a mold surface complementary in shape to the surface of the over cladding layer. The mold was placed on a molding stage, with the cavity positioned to face upward. Then, the cavity was filled with the material for the formation of the over cladding layer.

Then, the light-emitting main core, the light-emitting branch cores, and the light-receiving cores patterned on the surface of the under cladding layer were positioned relative to the cavity of the mold. In that state, the under cladding layer was pressed against the mold, so that the light-emitting main core, the light-emitting branch cores, and the light-receiving cores were immersed in the material for the formation of the over cladding layer. In this state, exposure was performed at an integrated dose of 8000 mJ/cm² by irradiating the material for the formation of the over cladding layer with ultraviolet light through the mold. Thus, the over cladding layer was formed in which a portion thereof corresponding to the tips of the light-emitting branch cores and a portion thereof corresponding to the tips of the light-receiving cores were each in the form of a convex lens portion. The convex lens portion had a substantially quadrantal curved lens surface (having a radius of curvature of 1.4 mm) as seen in sectional side view.

Next, the over cladding layer was removed from the mold. At this time, the over cladding layer was removed together with the substrate, the under cladding layer, the light-emitting main core, and the light-emitting branch cores on the light-emitting side, and the over cladding layer was removed together with the substrate, the under cladding layer, and the light-receiving cores on the light-receiving side.

Then, the substrate was stripped from the under cladding layer. This stripping provided each light-emitting strip-shaped optical waveguide section (having a total thickness of 1 mm) including the under cladding layer, the light-emitting main core, the light-emitting branch cores and the over cladding layer, and provided each light-receiving strip-shaped optical waveguide section (having a total thickness of 1 mm) including the under cladding layer, the light-receiving cores and the over cladding layer.

A rectangular frame-shaped retainer plate made of stainless steel (having a thickness of 0.5 mm) was prepared. The retainer plate had a hollow input-use interior in the form of a rectangle that was 30 cm in length and 30 cm in width. The strip-shaped optical waveguide sections were affixed to a portion of a surface of the retainer plate which was outside the hollow input-use interior. At this time, the ending end of the light-emitting main core and the ending ends of the light-receiving cores were positioned at one corner of the rectangular frame. Further, the void was provided (with reference to FIGS. 1A and 1B) between the ending end of the light-emitting main core and the ending ends of the light-receiving cores. In this manner, the rectangular frame-shaped optical waveguide was produced.

### <Production of Input Device>

Next, a light-emitting element (SM85-2N001 available from Optowell Co., Ltd.) was connected to the starting end of the light-emitting main core, and a light-receiving element (S-10226 available from Hamamatsu Photonics K.K.) was connected to the ending ends of the light-receiving cores. Thereafter, the top surface of the over cladding layer except the lens portion, the light-emitting element, and the light-receiving element were covered with a rectangular frame-shaped protective plate made of stainless steel (having a thickness of 0.5 mm). This provided an input device.

### Inventive Example 2

### <Production of Input Device>

An aluminum tape (having a thickness of 100 μm) was affixed in the void provided at one corner of the rectangular frame-shaped optical waveguide in Inventive Example 1 (with reference to FIGS. 5A and 5B). Other parts in Inventive Example 2 were similar to those in Inventive Example 1 described above.

### Inventive Example 3

### <Production of Input Device>

The void provided at one corner of the rectangular frame-shaped optical waveguide in Inventive Example 1 was filled with an epoxy resin containing a light absorbing agent (DY-150H-30 available from Toyobo Co., Ltd.) (with reference to FIGS. 6A and 6B). The proportion of the light absorbing agent contained in the epoxy resin was as follows: 30 parts by weight of the light absorbing agent based on 100 parts by weight of the epoxy resin. Other parts in Inventive Example 3 were similar to those in Inventive Example 1 described above.

### Comparative Example

### <Production of Input Device>

An input device was produced in which no void was provided between the ending end of the light-emitting main core and the light-receiving element in Inventive Example 1 (with reference to FIGS. 7A to 7C). Specifically, the under cladding layer and the over cladding layer which were stacked together were formed in a portion corresponding to the void of Inventive Example 1.

### <Received Light Intensity in Light-Receiving Element>

The received light intensity in the light-receiving element which resulted from light beams leaking through the ending end surface of the light-emitting main core toward the light-receiving element was measured in the input device of each of Inventive Examples 1 to 3 and Comparative Example. The result was that the descending order of received light intensity was as follows: Comparative Example, Inventive Example 1, Inventive Example 3, and Inventive Example 2. In particular, the received light intensity in Inventive Example 2 (with the aluminum tape) was approximately zero.

This result shows that Inventive Examples 1 to 3 prevent the light beams leaking through the ending end surface of the light-emitting main core toward the light-receiving element from reaching the light-receiving element, as compared with Comparative Example. In particular, the aluminum tape used in Inventive Example 2 proved to be especially effective as a light-shielding member.

### <Operation Check of Input Device>

Further, a personal computer was prepared.

Software (a program) for converting coordinates in the region within the hollow input-use interior of the rectangular frame-shaped optical waveguide of the input device of each of Inventive Examples 1 to 3 and Comparative Example into coordinates on the screen of a display to display a character or the like inputted by means of the input device on the display is incorporated in the personal computer. The personal computer included a receiving means so as to be able to receive radio waves (information) from a wireless module of the input device. The personal computer and the input device were connected for transmission of information therebetween by radio.

The input device in each of Inventive Examples 1 to 3 and Comparative Example described above was placed on a paper sheet, with the stainless steel retainer plate downside. Then, a character was inputted with a pen into the paper sheet revealed in the region within the hollow input-use interior. The result was that the inputted character was properly displayed on the display in Inventive Examples 1 to 3, whereas part of the inputted character was not properly displayed in Comparative Example.

A result showing a tendency similar to that in Inventive Examples 2 and 3 described above was obtained in an input device in which an aluminum plate, rubber and paper were provided in the void at the corner of the optical waveguide of Inventive Example 1 described above in a manner similar to that in Inventive Examples 2 and 3.

The input device is applicable to the addition of new information such as characters, drawings and marks to documents and the like appearing on a display, and to a detection means for detecting a finger touch position on a touch panel.

Although specific forms of embodiments of the instant invention have been described above and illustrated in the accompanying drawings in order to be more clearly understood, the above description is made by way of example and not as a limitation to the scope of the instant invention. It is contemplated that various modifications apparent to one of ordinary skill in the art could be made without departing from the scope of the invention.

What is claimed is:

1. An input device, comprising:
a frame-shaped optical waveguide having first and second sections opposed to each other in the form of a frame, the first section including a light-emitting main core and a plurality of branch cores branching off from the main core, the second section including a plurality of light-receiving cores disposed in juxtaposition, the branch cores and the light-receiving cores having respective tip surfaces positioned on inner edges of the frame, the tip surfaces of the branch cores and the tip surfaces of the light-receiving cores being opposed to each other;
a light-emitting element connected to the starting end of the light-emitting main core of the optical waveguide; and
a light-receiving element connected to the ending ends of the light-receiving cores of the optical waveguide,
the light-receiving element being positioned close to the ending end of the light-emitting main core,
wherein most of the light beams emitted from the light-emitting element and traveling from the starting end of the light-emitting main core toward the ending end thereof exit the tip surfaces of the branch cores, and the remainder of the light beams leak through the ending end surface of the light-emitting main core toward the light-receiving element, and
wherein a void is provided between the ending end of the light-emitting main core and the light-receiving element, there being an air space provided by air positioned in the void, the air space serving as a light transmission preventing means for diffusing the leaking light beams to prevent the leaking light beams from reaching the light-receiving element.

2. The input device according to claim 1, wherein a light-shielding member is provided in the void.

3. The input device according to claim 2, wherein the light-shielding member includes a metal tape or a resin containing a light absorbing agent.
